(19) United States
(12) Patent Application Publication
(10) Pub. No.: US 2013/0146028 A1
(43) Pub. Date: Jun. 13, 2013

(54) Internal combustion engine with fuel supply device

(71) Applicant: ANDREAS STIHL AG & CO. KG, Waiblingen (DE)

(72) Inventors: Wolfgang Layher, Besigheim (DE); Christopher Tost, Affalterbach (DE); Martin Rieber, Stuttgart (DE); Arno Kinnen, Fellbach (DE); Michael Dietenberger, Waiblingen (DE)

(73) Assignee: ANDREAS STIHL AG & CO. KG, Waiblingen (DE)

(21) Appl. No.: 13/707,625

(22) Filed: Dec. 7, 2012

(30) Foreign Application Priority Data
Dec. 7, 2011 (DE) 10 2011 120 468.0

(51) Int. Cl. F02M 69/54

(52) U.S. Cl. CPC F02M 69/54
USPC 123/457

(57) ABSTRACT

An internal combustion engine has a fuel supply device, wherein the fuel supply device includes a fuel pump, a fuel pressure damper, an injection valve, and a fuel pressure regulator. The fuel pressure damper has a damper membrane separating a damper chamber and a damper back chamber from each other. The damper chamber of the fuel pressure damper is loaded with a first reference pressure. The fuel pressure regulator regulates a pressure of fuel supplied by the fuel pump to the injection valve based on a second reference pressure of the fuel pressure regulator. The first reference pressure and the second reference pressure are adjusted relative to each other.

### BACKGROUND OF THE INVENTION

The invention relates to an internal combustion engine with a fuel supply device wherein the fuel supply device comprises a fuel pump, a fuel pressure damper, and an injection valve. The fuel pressure damper comprises a damper membrane that separates a damper chamber from a damper back chamber, wherein the damper back chamber of the fuel pressure damper is loaded with a first reference pressure.

U.S. Pat. No. 5,419,686 discloses a fuel pump for a two-stroke engine that has a fuel pressure damper arranged downstream thereof. The fuel pressure damper has a spring-loaded membrane. The side of the damper membrane that is facing away from the fuel is loaded with atmospheric pressure. The position of the damper membrane depends on the fuel pressure. Primarily at low fuel pressures that are within the range of atmospheric pressure, fluctuations of the fuel pressure can cause very great deflections of the damper membrane so that the damper membrane works at a significant spacing relative to its central position. A sufficient damping action of he pressure fluctuations can therefore not be reliably ensured.

The invention has the object to provide an internal combustion engine with a fuel supply device of the aforementioned kind that ensures a uniform fuel supply to the internal combustion engine even at minimal fuel pressures.

### SUMMARY OF THE INVENTION

In accordance with the present invention, this is achieved in that the fuel supply device has a fuel pressure regulator that regulates the pressure of the fuel conveyed by the fuel pump to the injection valve based on a second reference of the fuel pressure regulator, wherein the first reference pressure of the fuel pressure damper and the second reference pressure are adjusted relative to each other.

It is provided that the fuel supply device comprises a fuel pressure regulator that regulates the pressure of the fuel that is conveyed by the fuel pump to the injection valve. Fuel pressure regulators are generally known in connection with fuel systems. In order to avoid an excessive deflection of the damper membrane in operation, it is now provided to match or adjust the first reference pressure, with which the damper back chamber of the fuel pressure damper is loaded, to the second reference pressure of the fuel pressure regulator. Matching (adjusting) of the reference pressures means in this connection that both reference pressures are selected such that possible pressure differences between the two reference pressures in the system are taken into consideration; in particular, the pressure differences are compensated. In this connection, the first reference pressure and the second reference pressure in operation advantageously change to the same degree so that a pressure difference between the reference pressures remains the same and can be compensated. The compensation of a pressure difference between the two reference pressures can be realized, for example, mechanically by means of an appropriate configuration of the stiffness of the membrane or an appropriate spring pretension. Also, an electronic compensation, for example, by an electronic control unit of the power tool, can be provided. The first and the second reference pressures can also be selected such that the two reference pressures in operation change in different ways. The reference pressures are however matched (adjusted) to each other such that the non-uniform change is negligibly small, i.e., the function is not compromised, or that the non-uniform changes of the two reference pressures are known and can be compensated, for example, by electronic compensation. By matching the two reference pressures, it can be ensured in a very simple way that the damper membrane in usual operation operates at a central position and, in this way, pressure fluctuations occurring in operation are dampened well.

Matching of the two reference pressures of fuel pressure regulator and fuel pressure damper relative to each other is advantageous in particular in fuel systems that operate with very minimal fuel pressure. In particular, the fuel pressure is in the range of ambient pressure. The fuel pressure can be, for example, in the range of 0 to 2 bar, in particular in the range of 0 to 500 mbar, above ambient pressure. For such a minimal overpressure of the fuel, the membrane of the fuel pressure damper is designed to be very soft so that already at minimal pressure fluctuations a deflection of the membrane can be realized. Already a minimal increase or reduction of the pressure in the damper back chamber of the fuel pressure damper relative to the fuel pressure, without compensation of the relative pressure change, can have the effect that the damper membrane is forced into an end position and, as a result of the increased counterpressure, no deflection of the damper membrane upon pressure fluctuations of the fuel pressure, and thus no damping action of the pressure fluctuations, is possible anymore. This is avoided in that the reference pressure of the fuel pump (fuel pressure regulator) is matched to the reference pressure of the fuel pressure damper.

Advantageously, the first reference pressure is identical to the second reference pressure. Compensation of pressure differences of the reference pressures is then obsolete. No additional measures for matching the reference pressures relative to each other are required. A particularly simple configuration results when the first reference pressure is the ambient pressure and the second reference pressure is also the ambient pressure. The reference pressure however can also be the pressure of the clean chamber of an air filter of the internal combustion engine. A different pressure can also be expediently used as the reference pressure. The damper chamber is advantageously arranged in the flow path of the fuel from the fuel pump to the injection valve. Due to the permanent flow through the damper chamber, the accumulation of gas bubbles can be substantially avoided. It can also be advantageous to arrange the damper chamber in the flow path of the fuel from the injection valve to the fuel tank of the fuel supply device. By means of the flow connection of the injection valve with the fuel tank, fuel that is conveyed to the injection valve but is not injected is returned to the fuel tank. A permanent flow through the damper chamber is thus also provided in case of an arrangement of the damper chamber downstream of the injection valve.

Advantageously, the injection valve is arranged in a holder which is secured on the internal combustion engine. The holder is advantageously made of a heat-insulating material, such as plastic material, so that the heat transmission to the injection valve is minimal and the formation of gas bubbles can thus be prevented. This is in particular advantageous in connection with after heating of the internal combustion engine when the engine is shut off. When the internal combustion engine is shut off, the cylinder of the engine is still hot but cooling air is no longer conveyed so that the heat from the cylinder can cause heating of the adjoining components. By configuring the holder of plastic material, the introduction of heat into the injection valve is reduced. The holder has advantageously a housing wherein the damper chamber of the fuel pressure damper is delimited by the housing of the holder. The fuel pressure damper is in particular integrated into the housing of the holder. In this way, the number of components to be mounted on the internal combustion engine can be kept small. By integration of the fuel pressure damper in the housing of the holder, it is also possible in a simple way to provide a very small spacing between the fuel pressure damper and the injection valve. Advantageously, the holder is arranged on the crankcase of the internal combustion engine and has an outlet passage for fuel that opens into the crankcase interior.

The damper back chamber of the fuel pressure damper is advantageously connected by an opening with the reference pressure, in particular with the ambient, and is covered by a cover that is air-permeable. The cover prevents soiling of the opening. This is in particular expedient when the internal combustion engine is used in a power tool, in particular in a hand-held power tool, that is exposed in operation to dirt. The cover is advantageously water-repellent. This configuration is provided in particular when the internal combustion engine is used in an environment where work is done in the presence of water, for example, in case of a cut-off machine that employs water. The cover is advantageously a sintered metal screen. Such a metal screen is permeable for air but acts as a water-repellent means so that it is prevented that water or other liquids can reach the damper back chamber of the fuel pressure damper. The sintered metal screen has moreover a sufficiently high mechanical stability. Advantageously, the free (unobstructed) passage area of the cover is comparatively large so that even in case of soiling of the cover, passage of air from the ambient is still possible. The pressure compensation through the cover can occur slowly because only long-term pressure changes must be compensated, such as pressure changes caused, for example, by heating of the air in the damper back chamber. The free passage area of the cover is advantageously at least approximately two times the size of the area of the surface of the damper membrane that is loaded with the reference pressure.

From the damper chamber a connecting passage extends advantageously to the injection valve; the length of the connecting passage from the damper chamber to the injection valve is very small. The length of the connecting passage is advantageously at most five times the length of the diameter of the connecting passage. Because of the short configuration of the connecting passage that is relatively short compared to its diameter, the liquid fuel column that is positioned between the injection valve and the fuel pressure damper is kept very small. In operation, the injection valve must open and close very quickly. Upon closing of the valve, a pressure surge is produced in the fuel supply line and the fuel flow will stop. When the valve shortly thereafter is opened again, the entire fuel column must be accelerated again. It has been found that this acceleration in case of the usually short valve switching times in fast-running internal combustion engines takes too long so that no sufficient fuel quantity is supplied. Due to the arrangement of the fuel pressure damper immediately upstream of the injection valve and due to the very short configuration of the connecting passage, the fuel quantity that is to be accelerated can be kept very minimal so that a sufficient fuel supply can be ensured in operation.

Advantageously, the damper membrane of the fuel pressure damper is loaded by a spring in the direction of the damper chamber. The spring defines the working range of the fuel pressure damper. The pretension of the spring is in particular adjustable so that manufacturing tolerances can be easily compensated and a precise adjustment of the pressure range in which the membrane is operating is enabled. The spring also assists in accelerating the fuel column in the connecting passage.

In order to avoid an excessive deflection of the damper membrane, it is provided that in the damper back chamber and in the damper chamber of the fuel pressure damper at least one stop for determining an end position of the damper membrane is disposed, respectively. The damper membrane has advantageously an outer rim. A minimal size can be achieved when the outer rim of the damper membrane is positioned in an imaginary plane that is positioned at an angle of less than 30 degrees relative to a longitudinal center axis of the injection valve. Advantageously, the imaginary plane extends approximately parallel to the longitudinal center axis of the injection valve.

Advantageously, the fuel pump has a pump housing. The fuel pressure regulator is advantageously arranged also in the pump housing of the fuel pump. In this way, a compact configuration is provided. The fuel pressure regulator is advantageously embodied in accordance with the configuration of a fuel pressure regulator provided in conventional diaphragm carburetors. The fuel pressure regulator has a control membrane that delimits a control chamber wherein at the inlet into the control chamber an inlet valve is arranged that is opened or closed as a function of the position of the control membrane. On the side of the control membrane that is facing away from the control chamber, advantageously a control back chamber is formed that is loaded with the second reference pressure. The fuel pump has advantageously a pump membrane that is loaded with the fluctuating pressure of the crankcase interior.

### BRIEF DESCRIPTION OF THE DRAWING

Embodiments of the invention will be explained in the following with the aid of the drawings.

FIG. 1 is a schematic illustration of a cut-off machine.

FIG. 2 is a section view of the internal combustion engine of the cut-off machine of FIG. 1.

FIG. 3 is a schematic illustration of the fuel supply device of the internal combustion engine.

FIG. 4 is a section view of the crankcase of the cut-off machine and a holder arranged thereat for holding the injection valve.

FIG. 5 is section view of the holder.

FIG. 6 is a schematic illustration of the areas of he cover and control membrane in the direction of arrow VI of FIG. 5.

FIG. 7 is a sectioned detail illustration o he fuel pressure damper when no fuel pressure is applied.

FIG. 8 is section view of the fuel pressure damper in operation,

FIG. 9 is a section of the fuel pressure damper at a fuel pressure that is too high.

FIG. 10 is a section of the crankcase of an embodiment of the cut-off machine and a holder arranged thereat for holding the injection valve.

FIG. 11 a schematic illustration of an embodiment of the fuel supply device of the internal combustion engine.

### DESCRIPTION OF THE PREFERRED EMBODIMENTS

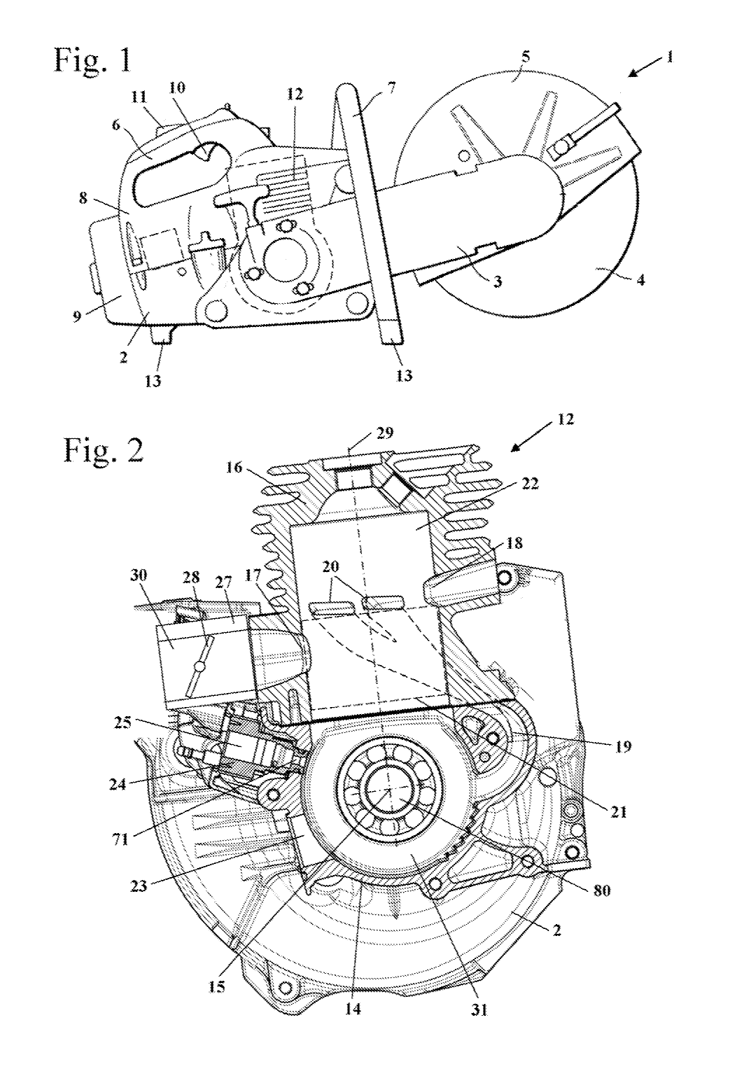

FIG. 1 shows an embodiment of a power tool, in particular, a hand-held portable power tool, such as a cut-off machine 1. The internal combustion engine with fuel supply device according to the invention can however also be provided for other power tools such as motor chainsaws, trimmers, blowers or the like.

The cut-off machine 1 has a housing 2 on which a cantilever arm 3 is secured that projects forwardly. At the free end of the cantilever arm 3 a cutter wheel 4 is rotatably supported and is driven by an internal combustion engine 12 that is arranged in the housing 2. The cutter wheel 4 is covered across more than half of its circumference by a protective cover 5. The housing 2 comprises a hood 8 on which a top handle 6 is formed. On the top handle 6, a throttle trigger 10 and a trigger lock 11 are pivotably supported. On the rear of the housing 2 that is facing away from the cutter wheel 4, an air filter cover 9 is secured. On the side of the housing 2 that is facing the cutter wheel 4 a handlebar 7 spans the housing 2. The cut-off machine 1 has support legs 13 with which the cut-off machine 1 can be placed onto the ground or onto another support surface.

FIG. 2 shows the internal combustion engine 12 in detail. The internal combustion engine 12 is a two-stroke engine. The internal combustion engine 12 can however also be a four-stroke engine that is lubricated by a fuel/oil mixture. The internal combustion engine 12 has a crankcase 14 on which additional housing parts are integrally formed. The crankcase 14 has a crankcase interior 31 in which a crankshaft 80 is rotatably supported for rotation about axis of rotation 15. The crankshaft 80 is connected by means of a connecting rod, not illustrated, with a piston 21 that is shown in dashed lines in FIG. 2. The piston 21 is reciprocatingly supported in a cylinder 16 and controls an inlet 17 that opens into the crankcase interior 31 when the piston 21 is in the area of top dead center. The piston 21 delimits the combustion chamber 22 formed within the cylinder 16. When the piston 21 is in the area of bottom dead center as indicated in FIG. 2, the crankcase interior 31 is connected by means of one or several transfer passages 19 with the combustion chamber 22. The transfer passages 19 open at transfer ports 20 into the combustion chamber 22. In this connection, a transfer passage 19 can branch into several branches that open with separate transfer ports 20 into the combustion chamber 22, as indicated in FIG. 2. An outlet 18 extends away from the combustion chamber 22 and is also controlled by the piston 21; when the piston 21 is in the area of bottom dead center as illustrated in FIG. 2, the outlet 18 is open.

For supply of combustion air the internal combustion engine 21 has an intake passage 30 that is passing through a throttle housing 27, in the throttle housing 27 a throttle element (in the illustrated embodiment a throttle flap 28) is arranged and the throttle trigger 10 is acting on the throttle element. For supplying, an injection valve that is not illustrated in FIG. 2 is provided. The injection valve is arranged in a receptacle 25 of a holder 24 on the crankcase 14. As shown in FIG. 2, the holder 24, in the usual rest position of the cut-off machine 1 on a flat support surface as shown in FIG. 1, is arranged immediately underneath the throttle housing 27 and secured on the crankcase 14. The holder 24 has an outlet passage 71 for fuel that opens into the crankcase interior 31. Adjacent to the holder 24 a mounting opening 23 is formed on the crankcase 14 that serves for mounting a pressure-temperature sensor therein and that is arranged below the holder 24 in the rest position.

In operation, when the piston 21 is at top dead center, combustion air is taken in through the intake passage 30 into the crankcase interior 31. The injection valve supplies fuel into the crankcase interior 31. When the piston 21 is at bottom dead center, the fuel/air mixture flows from the crankcase interior 31 through the transfer passage(s) 19 and transfer ports 20 into the combustion chamber 22. Upon upward stroke of the piston 21, the mixture in the combustion chamber 22 is compressed and ignited by a spark plug, not illustrated, when the piston 21 is at top dead center. The piston 21 is accelerated in the direction of the crankcase 14. As soon as the outlet 18 is opened by the piston 21, the exhaust gases escape from the combustion chamber 22 and fresh mixture flows from the crankcase interior 31 through the transfer passage(s) 19 into the combustion chamber 22. The piston 21 moves in the cylinder 16 in the direction of a longitudinal cylinder axis 29. The longitudinal cylinder axis 29, in the usual rest position of the cut-off machine 1 illustrated in FIG. 1, approximately vertical or is slanted slightly relative to the vertical.

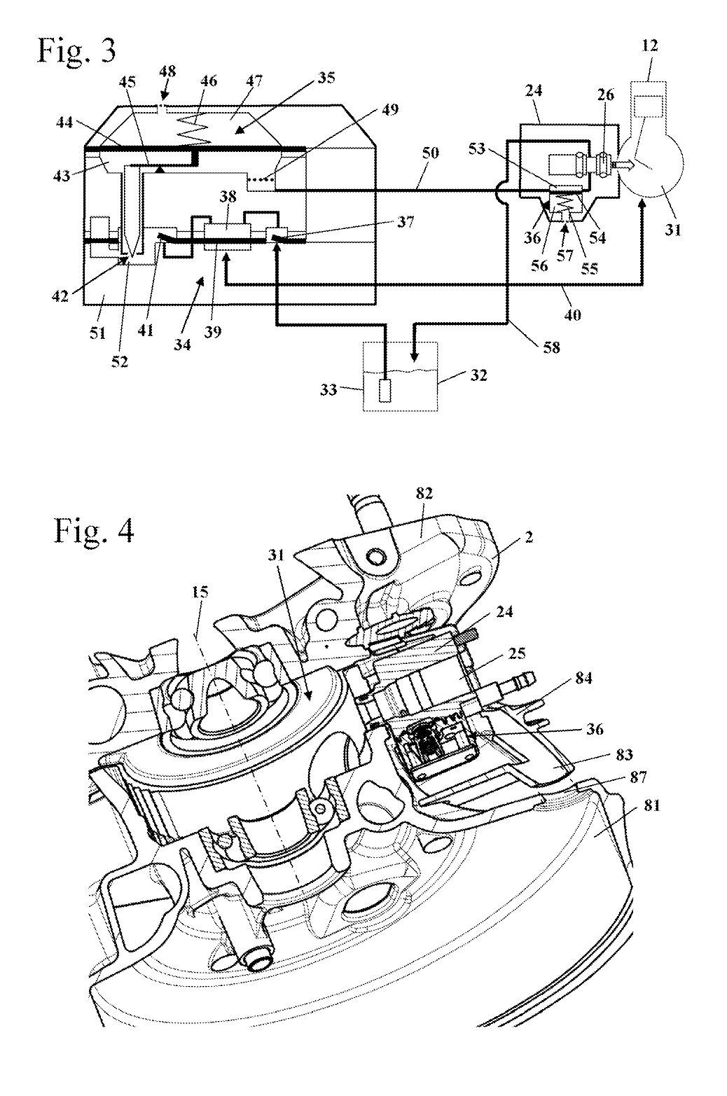

FIG. 3 shows the fuel supply device of the internal combustion engine 12 in detail. The cut-off machine 1 has a fuel tank 32 into which a suction head 33 projects. The fuel supply device has a fuel pump 34 that has a pump chamber 38 delimited by a pump membrane 39. Fuel from the fuel tank 32 is sucked into the pump chamber 38 by the suction head 33 via a suction valve 37 that is embodied as a check valve. The fuel is conveyed through a pressure valve 41 that is arranged downstream of the pump chamber 31 and is also embodied as a check valve into the fuel chamber 52. The pump membrane 39 is loaded at its side that is facing away from the pump chamber 38 by means of an impulse line 40 with the fluctuating pressure of the crankcase interior 31.

The fuel pump 34 is arranged in a pump housing 51 in which also a fuel pressure regulator 35 is arranged. The fuel pressure regulator 35 is arranged downstream of the fuel pump 44. The fuel pressure regulator 35 has a control membrane 44 that separates a control chamber 43 from a control back chamber 47. The control chamber 43 is connected by means of an inlet valve 42 with the fuel chamber 52 of the fuel pump 34. The inlet valve 42 is formed by an inlet needle that is arranged on a lever 45. The second end of the lever 45 is connected to the control membrane 44. As a function of the position of the control membrane 44, the inlet valve 42 opens and doses. The control membrane 44 is loaded by a spring 46 in the direction toward the control chamber. In the embodiment, the spring 46 is a pressure spring and is arranged in the control back chamber 47. The control back chamber 47 is loaded via an opening 48 with reference pressure which is ambient pressure in the embodiment. At the outlet of the control chamber, a fuel screen 49 is provided through which the fuel flows from the control chamber 43 into a fuel line 50.

By means of the fuel line 50 the fuel flows into a fuel pressure damper 36 which is arranged immediately adjacent to the injection valve 26 that is schematically illustrated in FIG. 3. The fuel pressure damper 36 has a damper membrane 54 that separates a damper chamber 53 from a damper back chamber 56. The fuel of the fuel line 50 flows through the damper chamber 53. The damper membrane 54 is loaded by a spring 55 in the direction toward the damper chamber 53. In the embodiment, the spring 55 is formed as a pressure spring and is arranged in the damper back chamber 56. The damper back chamber 56 is loaded via an opening 57 with the same reference pressure with which the fuel pressure regulator 35 is loaded this pressure is the ambient pressure in the illustrated embodiment.

The fuel flows from the damper chamber 53 to the injection valve 26. The injection valve 26 supplies the fuel into the crankcase interior 31. Fuel that is not supplied to the crankcase interior 31 is returned by return line 58 to the fuel tank 32.

FIG. 4 shows the constructive arrangement of the holder 24 and of the fuel pressure damper 36 at the circumference of the crankcase 14 in a perspective illustration that is sectioned at a slant. As shown in FIG. 4, the holder 24 and the fuel pressure damper 36 are positioned adjacent to each other in the direction of the axis of rotation 15 of the crankshaft. The holder 24 is positioned adjacent to a starter housing 82 in which the starter device for the internal combustion engine 12 is arranged. The starter housing 82 houses also a centrifugal clutch as well as a pulley for driving the drive belt of the cutter wheel 4. The fuel pressure damper 36 is positioned adjacent to a fan wheel housing 81 in which the fan wheel of the internal combustion engine is rotating for conveying cooling air. The pressure area of the fan wheel housing 81 is connected by a passage 83, indicated only schematically in FIG. 4, with a cooling housing 84 in which the holder 24 and the fuel pressure damper 36 are arranged. By means of passage 83, the fuel pressure damper 36 and the holder 24 with the injection valve 26 are actively cooled.

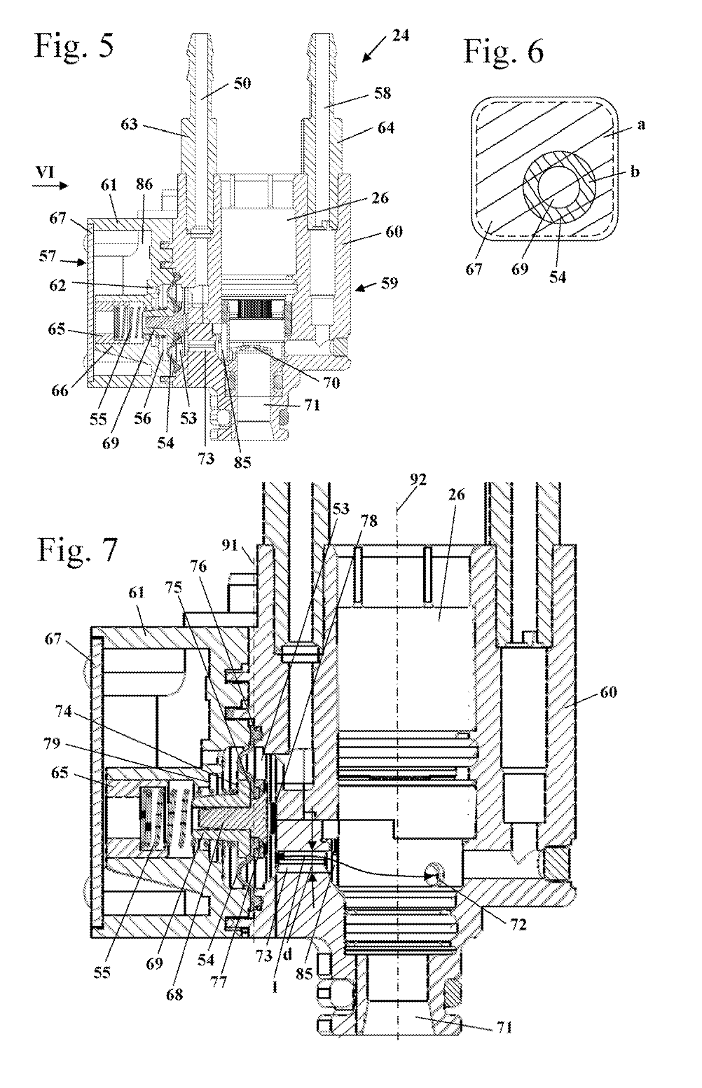

FIG. 5 shows the design of the holder 24 in detail. The holder 24 has a housing 59 that comprises a first housing part 60 and a second housing part 61. On the first housing part 60 a first fuel socket 63, in which the fuel line 50 is embodied, as well as a second fuel socket 64, in which the return line 58 is embodied, are secured. As shown in FIG. 5, the fuel line 50 opens in an outwardly positioned area in radial direction into the damper chamber 53. A connecting passage 7 3 extends from the damper chamber 53 to the injection valve 26. The connecting passage 73 opens into an annular space 85 at the circumference of the injection valve 26. The annular space 85 is connected by means of an inlet opening 72 illustrated in FIG. 7 with the interior of the injection valve 26. The fuel exits the injection valve 26 by means of fuel opening 70, illustrated in FIG. 5; the fuel opening 70 opens into the outlet passage 71. The fuel opening 70 is opened and closed by the injection valve 26.

As shown in FIG. 5, the damper back chamber 56 is formed in the second housing part 61. The area that is immediately adjacent to the damper membrane 54 is connected by one or several connecting openings 62 with an area 86 of the damper chamber 53. The area 86 has the opening 57 relative to the ambient. The opening 57 is covered by a cover 67 that is air-permeable and in particular water-repellent or water-impermeable. The cover 67 is advantageously a sintered metal screen. As shown in FIG. 5, the spring 55 is supported on a plug 65 which is secured in a securing element 66, for example, is screwed or press-fit into the securing element 66. The position of the plug 65 in the securing element 66 can be changed at the time of producing the fuel pressure damper 36. Accordingly, the pretension of the spring 55 and thus the position of the damper membrane 50 can be adjusted with respect to the desired fuel pressure.

As is shown in the schematic illustration of FIG. 6, the free passage area a of the cover 67 is significantly greater than the area b of the damper membrane 54 that is loaded in the damper back chamber 56. The free passage area a is advantageously at least two times, in particular at least three times to 10 times, the size of the area b of the damper membrane 54 that is loaded directly by the reference pressure. Even for a partial soiling of the cover 67 it is ensured in this way that the ambient pressure is present at the damper membrane 54. Due to the cover 67, the pressure between the ambient and the damper back chamber 56 can be compensated. The pressure compensation can occur slowly, in particular when the cover 67 is soiled greatly. Through the cover 67, only a compensation of slow changes of the pressure level in the damper back chamber 56 must take place, for example, a change caused by heating of the fuel pressure damper 36 during operation of the internal combustion engine 12 with the associated enlargement of the volume of the air in the damper back chamber 56.

As shown in FIGS. 5 and 7, the damper membrane 54 is secured on a fastening bushing 69. The area of the damper membrane 54 which is covered by the fastening bushing 69 is not part of the loaded area b.

FIG. 7 shows the fixation of the damper membrane 54 in detail. The damper membrane 54 has an inner rim 75 that is secured between the fastening bushing 69 and a fastening pin 68 that is pressed in from the opposite side. The fastening pin 68 has a fastening rim 77 that forces the inner rim 75 of the damper membrane 54 against a rim of the fastening bushing 69 and thereby secures it. The outer rim 76 of the damper membrane 54 is clamped between the two housing parts 60 and 61 and is positioned in an imaginary plane 91. In the embodiment, the imaginary plane 91 extends parallel to a longitudinal center axis 92 of the injection valve 26. Advantageously, the imaginary plane 91 is positioned relative to the longitudinal center axis 92 of the injection valve 26 at an angle that is smaller than approximately 30 degrees. As also shown in FIG. 7, the fastening bushing 69 has a support surface 74 on which one end of the spring 55 formed as a pressure spring is supported. The fastening bushing 69 projects into the interior of the spring 55 and forms a guide for the spring 55. The other end of the spring 55 is supported on the plug 65.

The connecting passage 73 is very short. As shown in FIG. 7, the connecting passage 73 has a length l that is only minimally greater than the diameter d of the connecting passage 73. The length l is advantageously at most five times the length of the diameter d of the connecting passage 73. The length l is significantly smaller than the diameter of the damper membrane 54. The length l is measured from the exit of the damper chamber 53 to the inlet into the annular space 85.

In FIG. 7, the damper membrane 54 is arranged in a first end position. In this end position, the fastening pin 68 is resting on a stop 78 that is arranged in the damper chamber 53. This position of the damper membrane 54 results when the fuel in the damper chamber 53 is pressureless or no fuel is present in the damper chamber 53.

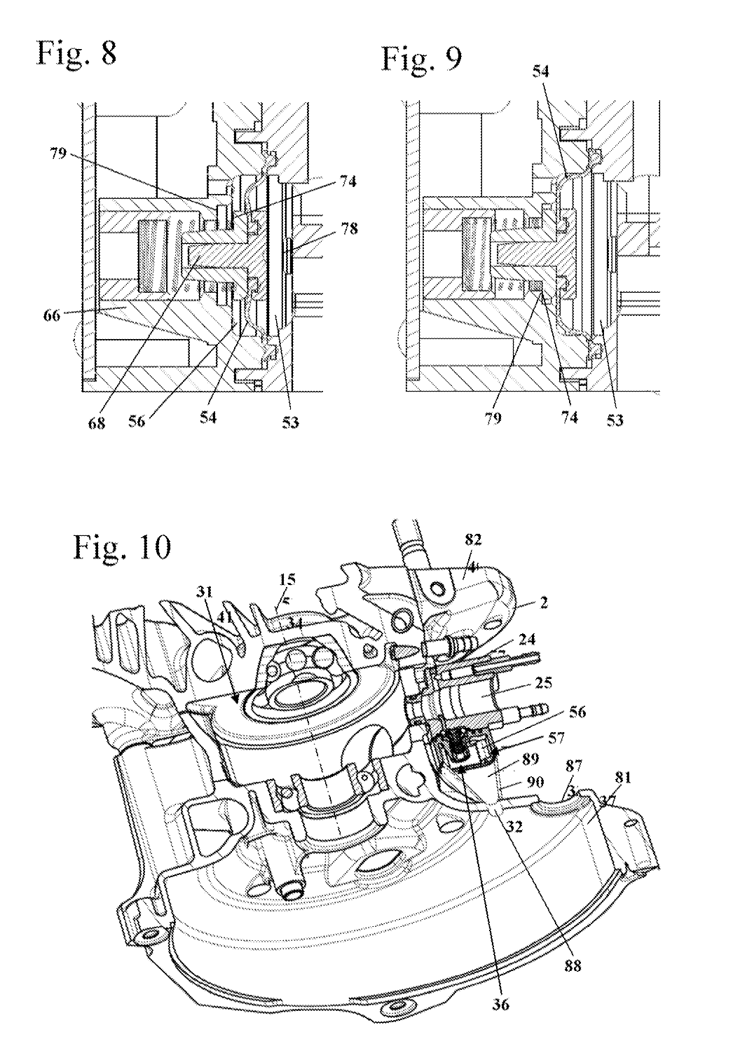

In FIG. 8, the damper membrane 54 is shown in its central position. The damper membrane 54 is advantageously in this position when in operation. The fastening pin 68 has a spacing to the stop 78. On the securing element 66, a stop 79 is formed relative to which the support surface 74 also has a spacing in the central position illustrated in FIG. 8. For example, the operational pressure can be approximately 100 mbar overpressure relative to ambient pressure.

FIG. 9 shows the damper membrane 54 in its other end position. In this end position, the support surface 74 is resting on the stop 79. This position results when the pressure of the fuel in the damper chamber 53 is too high and, for example, is approximately 130 mbar. Due to the stops 78 and 79, an excessive deflection of the damper membrane 54 is avoided. An excellent fuel damping action is provided in the central position of the damper membrane 54 illustrated in FIG. 8. In order to ensure that, in operation, the damper membrane 54 operates in its central position, it is provided that in the damper back chamber 56 of the fuel pressure damper 36 and in the damper back chamber 47 of the fuel pressure regulator 35 the same reference pressure exists. In the embodiment, this is the ambient pressure. However, the reference pressure can be a different pressure, for example, the pressure in the dean room of an air filter of the internal combustion engine 12. Because the fuel pressure regulator 35 and the fuel pressure damper 36 operate at the same reference pressure, adjusting or matching of the fuel pressure regulator 35 and fuel pressure damper 36 is possible in a simple way. Even for very minimal fuel pressures, where the spring 55 in the fuel pressure damper 36 is designed to be very weak, it can thus be ensured that the damper membrane 54 operates in its central position when in operation and, in this way, can dampen the resulting pressure fluctuations very well.

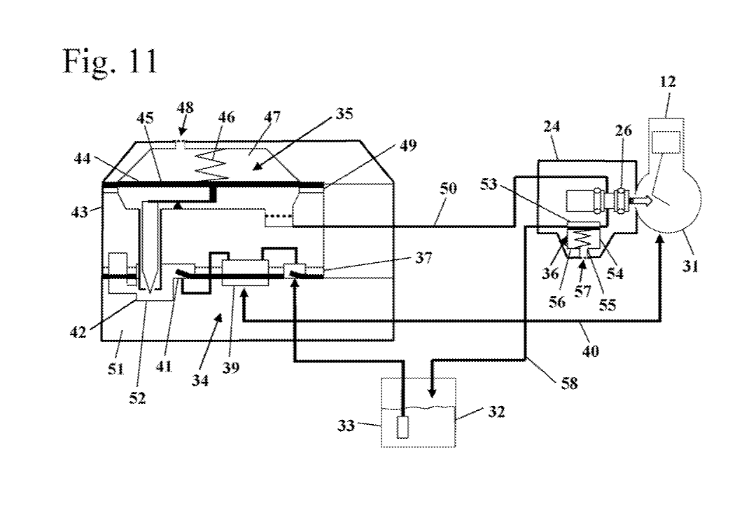

FIG. 10 shows an embodiment of the crankcase 14 of the cut-off machine 1. Components identified with the same reference characters as in the preceding Figures indicate corresponding components. In the illustrated embodiment, the damper back chamber 56 of the fuel pressure damper 36 is not loaded with ambient pressure but with the pressure in the fan wheel housing 81. The opening 57 is connected with the connecting opening 88 in the fan wheel housing 81 by means of the passage 89, which is extending in a funnel 90 in the illustrated embodiment. In the embodiment, the connecting opening 88 is arranged in an overpressure area of the fan wheel housing 81 so that the reference pressure of the fuel pressure damper 36 in the area of the internal combustion engine 12 is higher than the ambient pressure. The connecting opening 88 can also be arranged in an underpressure area of the fan wheel housing. The reference pressure of the fuel pressure regulator 35, not illustrated in FIG. 10, is ambient pressure as in the first embodiment so that the reference pressures of fuel pressure regulator 35 and fuel pressure damper 36 are different.

The different reference pressures of fuel pressure regulator 35 and fuel pressure damper 36 are compensated. For this purpose, the spring 55 of the fuel pressure damper 36 can be designed to be appropriately weak or can be eliminated entirely. Alternatively, or in addition, compensation by an appropriate pretension of the damper membrane 54 of the fuel pressure damper 36 can be realized. It also possible to simply ignore the differences of the reference pressures. Alternatively, an electronic compensations of the difference of the reference pressures can be provided.

In an alternative configuration a digital pressure transducer is provided that measures one or both reference pressures and electronically compensates the occurring pressure differences. In addition, an actuator can be provided that in accordance with the measured pressure differences is acting on the fuel pressure damper and compensates the pressure differences in this way. This can be done for example by mechanical adjustment of a contact surface of the spring 55. Accordingly, the pretension of the spring 55 and thus the rest position of the damper membrane 53 are changed. In this way, pressure differences between the reference pressures can be compensated.

In the embodiment illustrated in FIG. 11 of the fuel supply device of a cut-off machine 1 (FIG. 1), the fuel pressure damper 36 is not arranged in the fuel line 50 that is extending from the fuel pressure regulator 35 to the injection valve 26 but downstream of the injection valve 26 in the return line 58. The pressure in the return line 58 corresponds substantially to the pressure in the fuel line 50, in particular when the injection valve 26 is closed. In this way, in the embodiment illustrated in FIG. 11 the same pressure damping action is achieved as in the embodiment illustrated in FIG. 3. In the embodiment illustrated in FIG. 11, the damper chamber 53 of the fuel pressure damper 36 is also flowed through by the fuel so that formation of gas bubbles is avoided. The configuration of the fuel supply device of FIG. 11 corresponds, with the exception of the arrangement of the fuel pressure damper 36, to the configuration of the embodiment illustrated in FIG. 3. Same reference characters characterize elements that correspond to each other.

The specification incorporates by reference the entire disclosure of German priority document 10 2011 120 468.0 having a filing date of Dec. 7, 2011.

While specific embodiments of the invention have been shown and described in detail to illustrate the inventive principles, it will be understood that the invention may be embodied otherwise without departing from such principles.

What is claimed is:

1. An internal combustion engine comprising:
a fuel supply device, wherein the fuel supply device comprises a fuel pump, a fuel pressure damper, an injection valve, and a fuel pressure regulator;
wherein the fuel pressure damper comprises a damper chamber and a damper back chamber and further comprises a damper membrane separating the damper chamber and the damper back chamber from each other;
wherein the damper chamber of the fuel pressure damper is loaded with a first reference pressure;
wherein the fuel pressure regulator has a second reference pressure and regulates a pressure of fuel supplied by the fuel pump to the injection valve based on the second reference pressure;
wherein the first reference pressure and the second reference pressure are adjusted relative to each other.

2. The internal combustion engine according to claim 1, wherein the first reference pressure is identical to the second reference pressure.

3. The internal combustion engine according to claim 2, wherein the first reference pressure is ambient pressure and the second reference pressure is ambient pressure.

4. The internal combustion engine according to claim 1, wherein the damper chamber is arranged in a flow path of the fuel from the fuel pump to the injection valve.

5. The internal combustion engine according to claim 1, wherein the damper chamber is arranged in a flow path of the fuel from the injection valve to a fuel tank of the fuel supply device.

6. The internal combustion engine according to claim 1, further comprising a holder secured on the internal combustion engine, wherein the injection valve is arranged in the holder.

7. The internal combustion engine according to claim 6, wherein the holder has a housing and wherein the damper chamber of the fuel pressure damper is delimited by the housing of the holder.

8. The internal combustion engine according to claim 6, further comprising a crankcase, wherein the holder is arranged on the crankcase and has an outlet passage for the fuel, wherein the outlet passage opens into a crankcase interior of the crankcase.

9. The internal combustion engine according to claim 1, wherein the fuel pressure damper has an opening and the damper back chamber is loaded with the first reference pressure through the opening, wherein the fuel pressure damper has a cover that covers the opening and the wherein cover is air-permeable.

10. The internal combustion engine according to claim 9, wherein the cover is a sintered metal screen.

11. The internal combustion engine according to claim 1, comprising a connecting passage extending from the damper chamber to a receptacle in which the injection valve is received, wherein a length of the connecting passage measured between the damper chamber and the receptacle is not more than five times a length of a diameter of the connecting passage.

12. The internal combustion engine according to claim 1, wherein the fuel pressure damper further comprises a spring and the spring loads the damper membrane in a direction toward the damper chamber, wherein a pretension of the spring is adjustable.

13. The internal combustion engine according to claim 1, wherein the damper back chamber and the damper chamber each have at least one stop that determines an end position of the damper membrane.

14. The internal combustion engine according to claim 1, wherein the damper membrane has an outer rim that is positioned in an imaginary plane that is positioned at an angle of less than approximately 30 degrees relative to a longitudinal center axis of the injection valve.

15. The internal combustion engine according to claim 1, wherein the fuel pump has a pump housing and the fuel pressure regulator is arranged in the pump housing.

16. The internal combustion engine according to claim 1, wherein the fuel pressure regulator has a control membrane that delimits a control chamber, wherein the control chamber has an inlet and an inlet valve arranged at the inlet, wherein the inlet valve opens or closes as a function of a position of the control membrane.

17. The internal combustion engine according to claim 16, wherein on a side of the control membrane that is facing away from the control chamber a control back chamber is formed that is loaded with the second preference pressure.

18. The internal combustion engine according to claim 1, further comprising a crankcase, wherein the fuel pump has a pump membrane that is loaded by fluctuating pressure of a crankcase interior of the crankcase.
